(19) United States
(12) Patent Application Publication
(10) Pub. No.: US 2011/0252990 A1
(43) Pub. Date: Oct. 20, 2011

(54) PRINTING RELIEF PLATE

(75) Inventors: Osamu SHIMAZAKI, Kanagawa-ken (JP); Norismasa Shigeta, Kanagawa-ken (JP)

(73) Assignee: FUJIFILM Corporation

(21) Appl. No.: 13/089,923

(22) Filed: Apr. 19, 2011

(30) Foreign Application Priority Data
Apr. 20, 2010 (JP) 2010-097196

(51) Int. Cl. B41C 1/18

(52) U.S. Cl. 101/401.1

(57) ABSTRACT

A printing relief plate, within a screen tint region, includes main halftone dot convexities, halftone dot convexities, and other halftone dot convexities, in which the heights of printing surfaces of the halftone dot convexities to which ink is applied differ from each other in a plurality of halftone dot convexity height levels.

### CROSS-REFERENCE TO RELATED APPLICATION

This application is based upon and claims the benefit of priority from Japanese Patent Application No. 2010-097196 filed on Apr. 20, 2010, of which the contents are incorporated herein by reference.

### BACKGROUND OF THE INVENTION

1. Field of the Invention

The present invention relates to a printing relief plate in which convexities (hereinafter referred to as halftone dot convexities), which are used in halftone dot printing for transferring ink to a print medium to print halftone dots thereon, are formed in plurality.

2. Description of the Related Art

Heretofore, printing relief plates have been used in flexography, for example. As well known in the art, flexography uses elastic plate materials together with aqueous and UV inks. Since the plate materials are elastic, they lend themselves to printing on corrugated cardboard materials having surface irregularities.

Flexography has been problematic in that, since the used plate materials are elastic, halftone dots that are printed tend to be large in size, resulting in high dot gain and graininess (i.e., density fluctuations indicative of image coarseness).

Japanese Laid-Open Patent Publication No. 2008-230195 discloses a printing relief plate for printing on a can barrel. The disclosed printing relief plate has convexities the height of which is smaller than the height of a solid area of the printing relief plate. According to this publication, convexities that are lower than the solid area are less liable to be deformed when pressed by a blanket, and hence such convexities are effective at preventing dot gain from increasing.

Japanese Laid-Open Patent Publication No. 2008-183888 also discloses a printing relief plate for printing on a can barrel. The disclosed printing relief plate has convexities for printing halftone dots the halftone dot area ratio of which is equal to or smaller than a prescribed value. The height of the convexities becomes lower as the halftone dot area ratio is reduced. According to the publication, convexities for printing halftone dots, the halftone dot area ratio of which is small, bite into a blanket by a reduced distance, thereby reducing enlargement of the small halftone dots.

Japanese Laid-Open Patent Publication No. 2007-185917 discloses a flexographic printing plate including a halftone dot area the height of which is smaller than the height of a solid area of the printing relief plate by 0 μm to 500 μm, at a halftone dot area ratio equal to or greater than 5% and equal to or smaller than 40% on printed images. According to the publication, it is possible to produce a printing relief plate that exhibits excellent dot gain quality.

Japanese Laid-Open Patent Publication No. 2006-095931 discloses a platemaking method for generally shortening a platemaking time required to produce a printing relief plate for flexography, using laser beams having first and second beam diameters.

However, the printing relief plates disclosed in Japanese Laid-Open Patent Publication No. 2008-230195, Japanese Laid-Open Patent Publication No. 2008-183888, Japanese Laid-Open Patent Publication No. 2007-185917, and Japanese Laid-Open Patent Publication No. 2006-095931 have the following problems.

The first problem is that, if the height (engraving lowering quantity) of the convexities for all of the halftone dots is changed altogether to a certain level at the same halftone dot area ratio, for example, as shown in FIG. 23A, with respect to a solid area 2 of the engraving plate, if lowered height level halftone dot convexities 4, 4a, 4b of the engraving plate are lowered altogether by a height hc, then in a printing process, almost no printing pressure is applied by the lowered halftone dot convexities 4a, 4b, which are disposed in a boundary region between the solid area 2 and the lowered halftone dot convexities 4, 4a, 4b. Therefore, a problem (referred to as a near-solid-area printing defect) results in which halftone dots are not printed, or the printed halftone dots become blurred within an area 8 of the print sheet 6.

More specifically, as shown in FIG. 23B, in a resultant print 6p, within a halftone dot area 4p near to a solid area 2p shown in crosshatching, a defect occurs in that an area 8p is produced in which the halftone dots are not printed or the density thereof becomes reduced.

The second problem is that, if the height (engraving lowering quantity) of the convexities for all of the halftone dots is changed altogether to a certain level at the same halftone dot area ratio, then during printing, for example, since printing pressure is applied unstably to adjacent halftone dot areas having different halftone dot area ratios, different printed areas tend to exhibit different printing densities. As a result, print reproducibility becomes unstable when prints are repeatedly produced.

### SUMMARY OF THE INVENTION

An object of the present invention is to provide a printing relief plate, which avoids localized enlargement of small halftone dots, reduces generation of printing defects near a solid area, and which is capable of reducing instabilities in printing pressure caused by making the heights of the halftone dot convexities lower in level.

According to an aspect of the present invention, there is provided a printing relief plate having a plurality of halftone dot convexities disposed on a surface of a plate material, for printing halftone dots on a print medium by transferring ink to the print medium, the printing relief plate comprising the halftone dot convexities formed adjacent to each other and having height levels that differ within a screen tint region.

According to the present invention, because the printing relief plate is formed to include the halftone dot convexities formed adjacent to each other and having height levels that differ within a given screen tint region, for example, by making the heights of the halftone dot convexities in the vicinity of the solid region to be of the same height as or slightly lower in height than the height of the solid region, generation of near-solid-area printing defects can be reduced or eliminated, and further, the height level of the halftone dot convexities can be set so that printing pressure is not applied unstably.

In this case, in the screen tint region, by providing the heights of the halftone dot convexities, which are formed adjacent to each other with differing height levels, so as to include at least three levels, more meticulous control is enabled, and a print quality having a suitable graininess on printed materials can be obtained.

Furthermore, in the screen tint region, among the heights of four halftone dot convexities that are formed adjacent to each other, preferably, a difference in height between a main halftone dot convexity the height of which is of a highest level and a halftone dot convexity the height of which is of a lowest level is at least 15 μm.

Even if engraving variances occur when the halftone dot convexities are formed, the variances are on the order of 10 μm at a maximum, and differences in height in the plural halftone dot convexities that constitute the screen tint region can be provided.

In this case, in the screen tint region, a density ratio at which main halftone dot convexities the height of which is of a highest level exist is equal to or greater than 5% and equal to or less than 50%. The density ratio at which the main halftone dot convexities exist, in the case it is considered to set such a density ratio digitally, may be set roughly at 1/16, ⅛, ¼, or ½.

Within the screen tint region, preferably, the main halftone dot convexities may be arranged in a dispersed fashion.

To facilitate explanation of this feature, for example, in a 4×4 square matrix screen tint region in which halftone dot convexities are spread thereover, in the case that a square shaped portion made up from 5×5 halftone dot convexities is considered, the main halftone dot convexities are dispersed at one vertex position of the square shaped portion and at a position inside of the opposing vertex on a diagonal line that passes between the one vertex position and the opposing vertex that is opposite to the one vertex position (see FIG. 12B).

As a result of the dispersed arrangement of the main halftone dot convexities, the printing pressure is made uniform, and in particular, printing pressure instabilities caused by making highlight gradations lower in level can be reduced, and localized enlargement of small halftone dots can be avoided.

In this instance, in case that the halftone dots are AM halftone dots, a distribution of centers of the main halftone dot convexities forms a portion of a distribution of centers of the halftone dot convexities. Stated another way, the distribution of centers of the main halftone dot convexities is a partial assemblage of an overall assemblage of centers of the halftone dot convexities.

To provide more detailed examples of the aforementioned dispersed arrangement, assuming that centers of the main halftone dot convexities are distributed at vertices and centers of a polygonal lattice, which is equilateral triangular shaped, square shaped, rectangular shaped, diamond shaped, parallelogram shaped, or regular hexagonal shaped, and wherein lengths of all sides or lengths of opposing sides of the polygonal lattice are equivalent, then the centers of the main halftone dot convexities are dispersed uniformly.

In this case, a positional error between center positions of the main halftone dot convexities and positions of vertices of a regular polygonal lattice the lengths of all sides of which are equal is ½ or less of a minimum value of the lengths of each of the sides that form the regular polygonal lattice. As a result, the uniform dispersion of the main halftone dot convexities is not impaired.

Furthermore, in case that the halftone dots are FM halftone dots, preferably, the distribution of centers of the main halftone dot convexities is based on a distribution of centers of blue noise type FM halftone dots. Because the visual perception of humans is such that certain spatial frequencies (generally 10 c/mm) and above are virtually imperceptible, by operation of a pseudo random pattern distribution so that the spatial frequency distribution of centers of the main halftone dot convexities becomes equal to or greater than this frequency, graininess can be rendered inconspicuous.

Preferably, the screen tint region is divided into halftone dot blocks, which are formed from a plurality of halftone dot convexities that are adjacent to each other, wherein an arrangement pattern of height levels of the halftone dot convexities in the halftone dot blocks is repeated periodically within the screen tint region.

For example, in case that the halftone dot blocks are constructed from 4×4 halftone dot convexities, such that the heights of the halftone dot convexities are in three levels, the number of halftone dot convexities that make up the main halftone dot convexities of a first-level height, the height of which is highest, is two in number, the number of halftone dot convexities of a second-level height, which is next highest, is six in number, and the number of halftone dot convexities of a third-level height, which is lowest, is eight in number, and at adjacent halftone dot blocks having the same halftone dot convexity arrangement, sides of halftone dot convexities of the same level are arranged so as not to be shared. As a result, smooth gradations with very few tone jumps can be achieved.

Similarly, in case that the halftone dot blocks are constructed from 2×2 halftone dot convexities such that the heights of the halftone dot convexities are in three levels, the number of halftone dot convexities that make up the main halftone dot convexities of a first-level height, the height of which is highest, is one in number, the number of halftone dot convexities of a second-level height, which is next highest, is one in number, and the number of halftone dot convexities of a third-level height, which is lowest, is two in number, and at adjacent halftone dot blocks having the same halftone dot convexity arrangement, sides of halftone dot convexities of the same level are arranged so as not to be shared. As a result, smooth gradations with very few tone jumps can be achieved.

Still further, the screen tint region may be divided into halftone dot blocks, which are formed from a plurality of halftone dot convexities that are adjacent to each other, wherein an arrangement pattern of height levels of the halftone dot convexities in the halftone dot blocks is repeated periodically within the screen tint region. In this instance, in case that the halftone dot blocks are constructed from 2×2 halftone dot convexities such that the heights of the halftone dot convexities are in two levels, the number of halftone dot convexities that make up the main halftone dot convexities of a first-level height, the height of which is highest, is one in number, and the number of halftone dot convexities of a second-level height, which is next highest, is three in number, and halftone dot blocks having the same halftone dot convexity arrangement are arranged continuously. As a result, smooth gradations with very few tone jumps can be achieved.

According to the present invention, since a structure is provided having sections in which the heights of halftone dot convexities formed adjacent to each other are arranged at different levels in a screen tint region of a printing relief plate, localized thickening of small halftone dots can be avoided, generation of printing defects near a solid area can be resolved, and further, instabilities in printing pressure caused by making portions of the halftone dot convexities lower in level can also be reduced.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic drawing of an example of a platemaking system in which a printing relief plate according to an embodiment of the invention is produced;

FIG. 2 is a schematic side elevational view showing basic structural details of a flexographic printing press, which incorporates a printing relief plate therein;

FIG. 3 is an enlarged fragmentary cross-sectional view of an example of the printing relief plate in accordance with the present embodiment;

FIG. 4 is a functional block diagram showing the detailed structure (functions) of a screening processor and a halftone dot convexity height level determiner in the platemaking system;

FIG. 5 is a diagram for explaining operations of the screening processor and the halftone dot convexity height level determiner;

FIG. 6 is a conversion characteristic diagram illustrating the manner in which image data is converted into halftone dot convexity height level data;

FIG. 7 is an explanatory drawing showing a repetitive arrangement pattern of halftone dot blocks;

FIG. 8 is a schematic plan view showing in outline the structure of a laser engraving machine for producing the printing relief plate;

FIG. 9 is a view showing an image formed on a print using a printing relief plate according to the present embodiment;

FIG. 10 is a view showing an image formed on a print using a printing relief plate according to another example of the present embodiment;

FIG. 11 is an explanatory drawing showing a repetitive arrangement pattern of another example of halftone dot blocks;

FIG. 12A is an explanatory drawing showing a repetitive arrangement pattern of still another example of halftone dot blocks;

FIG. 12B is a view showing a general expression of the printing relief plate produced based on the arrangement pattern of FIG. 12A;

FIG. 13 is a conversion characteristic diagram illustrating another example of the manner in which image data is converted into halftone dot convexity height level data;

FIG. 14 is a view showing detailed examples of the arrangement pattern of FIG. 12A, and detailed examples of printing relief plates (examples in which the halftone dot area ratio is comparatively high) produced based on such detailed examples;

FIG. 15 is a view showing detailed examples of the arrangement pattern of FIG. 12A, and detailed examples of printing relief plates (examples in which the halftone dot area ratio is comparatively low) produced based on such detailed examples;

FIG. 16A is an explanatory drawing showing a repetitive arrangement pattern of still another example of halftone dot blocks;

FIG. 16B is a view showing a general expression of the printing relief plate produced based on the arrangement pattern of FIG. 16A;

FIG. 17 is a view showing detailed examples of the arrangement pattern of FIG. 16A, and detailed examples of printing relief plates (examples in which the halftone dot area ratio is comparatively high) produced based on such detailed examples;

FIG. 18 is a view showing detailed examples of the arrangement pattern of FIG. 16A, and detailed examples of printing relief plates (examples in which the halftone dot area ratio is comparatively low) produced based on such detailed examples;

FIG. 19A is an explanatory drawing showing a repetitive arrangement pattern of still another example of halftone dot blocks;

FIG. 19B is a view showing a general expression of the printing relief plate produced based on the arrangement pattern of FIG. 19A;

FIG. 20 is a view showing detailed examples of the arrangement pattern of FIG. 19A, and detailed examples of printing relief plates (examples in which the halftone dot area ratio is comparatively high) produced based on such detailed examples;

FIG. 21 is a view showing detailed examples of the arrangement pattern of FIG. 19A, and detailed examples of printing relief plates (examples in which the halftone dot area ratio is comparatively low) produced based on such detailed examples;

FIG. 22 is a diagram showing the relationship between threshold data and the size of halftone dot cells at a screen angle of 45°;

FIG. 23A is a view showing a printing relief plate according to the related art; and

FIG. 23B is a view showing an image printed using the printing relief plate according to the related art.

### DESCRIPTION OF THE PREFERRED EMBODIMENTS

A printing relief plate according to preferred embodiments of the present invention, in relation to a platemaking system for producing the printing relief plate, will be described in detail below with reference to the accompanying drawings.

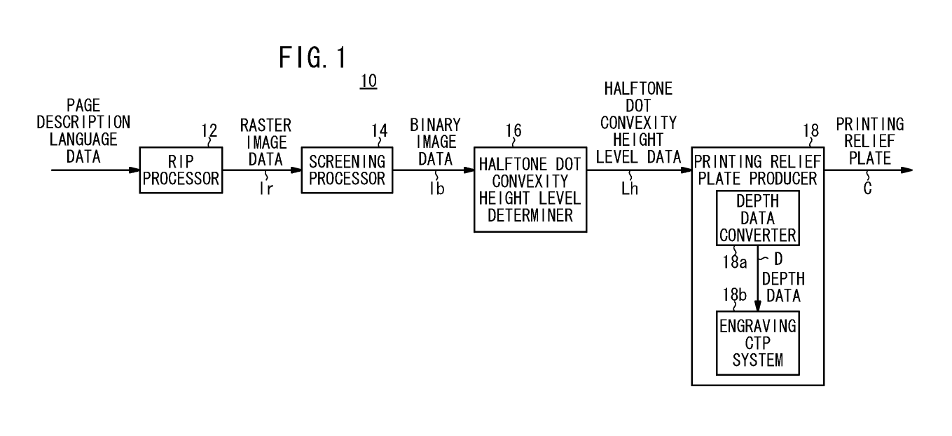

FIG. 1 is a block diagram of a platemaking system 10 (printing relief plate producing system) according to an embodiment of the present invention. As shown in FIG. 1, the platemaking system 10 basically comprises a RIP (Raster Image Processor) 12, a screening processor 14, a halftone dot printing convexity (also referred to as halftone dot convexity) height level determiner 16, and a printing relief plate producer 18.

The RIP 12 converts PDL (Page Description Language) data, such as PDF (Portable Document Format) data, PS (PostScript: registered trademark) data, or the like, which represent vector images of printed documents edited using a computer or the like, into raster image data Ir.

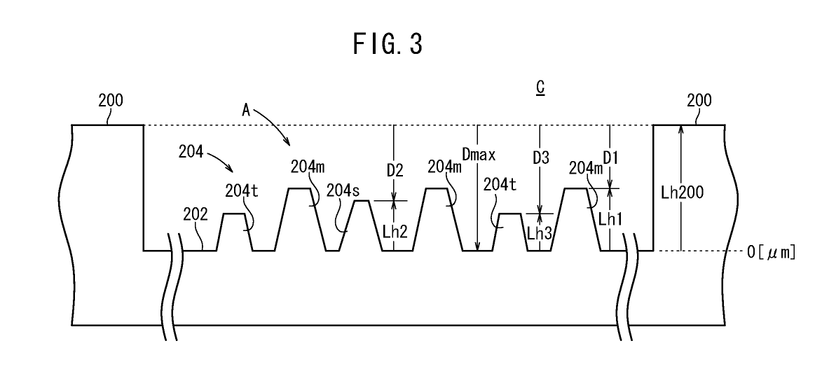

The raster image data Ir comprise image data Ii (pixel data), which adopt gradation values that usually, for example, are of 256 (0 through 255) gradation values. In the present embodiment, to facilitate understanding of the invention, it shall be assumed that the 256 gradation values have been converted into corresponding halftone dot area ratios Har in a range from 0% to 100%. More specifically, it is assumed that the image data Ii assume values in a range from 0% to 100%. If the image data Ii are represented by Ii=100, then a solid area 200 (see FIG. 3) is produced. If the image data Ii are represented by Ii=0, then halftone dot convexities (halftone dot convexities for printing halftone dots, or simply convexities) 204 (see FIG. 3) are not produced.

The screening processor 14 performs a screening process on the raster image data Ir, under conditions including a predetermined screen (an AM screen or an FM screen, and screen dot shapes), a screen angle, a screen ruling, etc., thereby converting the raster image data Ir into binary image data Ib.

The halftone dot convexity height level determiner 16 converts the binary image data Ib into halftone dot convexity height level data (also referred to as halftone dot convexity height levels) Lh.

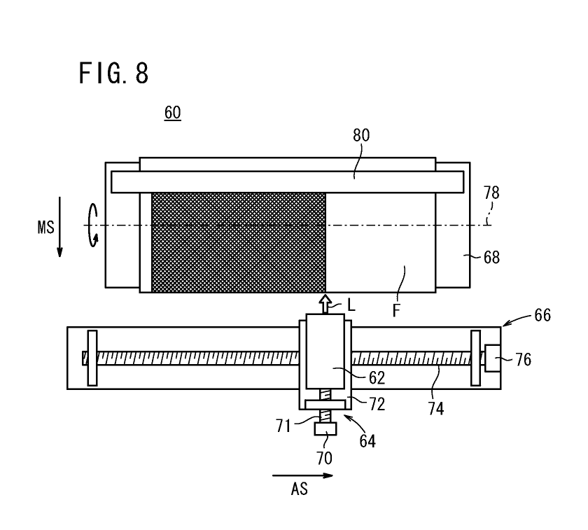

The printing relief plate producer 18 includes a depth data converter 18a, and an engraving CTP (Computer To Plate) system 18b including a laser engraving machine 60 (see FIG. 8). In addition, halftone dot convexity height level data Lh supplied from the halftone dot convexity height level determiner 16 are converted into depth data (engraving depth data) D by the depth data converter 18a that constitutes part of the printing relief plate producer 18. Based on such depth data D, the engraving CTP system 18b carries out a laser engraving process on a flexographic printing plate material F, which is an elastic material such as synthetic resin, rubber, or the like, to thereby produce a printing relief plate C in which a plurality of halftone dot convexities 204 are formed. As shown in FIG. 3, the halftone dot convexities 204 include main halftone dot convexities 204m and halftone dot convexities 204s, or main halftone dot convexities 204m, halftone dot convexities 204s, and halftone dot convexities 204t, for example.

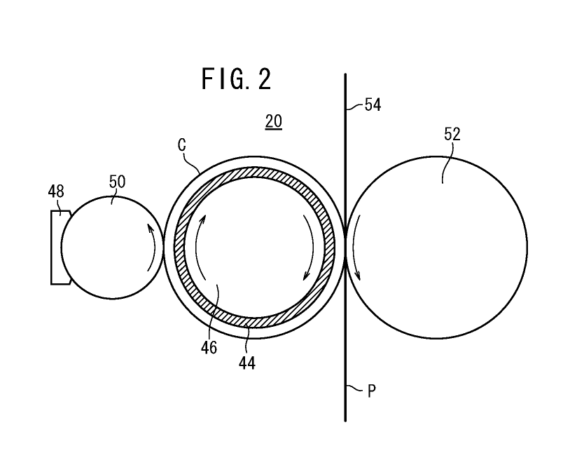

FIG. 2 shows basic structural details of a flexographic printing press 20. As shown in FIG. 2, the flexographic printing press 20 comprises a printing relief plate (flexographic printing plate) C produced by the above-mentioned printing relief plate producer 18, a plate cylinder 46 on which the printing relief plate C is mounted via a cushion tape 44 such as a double-sided adhesive tape or the like, an anilox roller 50, which is supplied with ink from a doctor chamber 48, and an impression cylinder 52.

When the flexographic printing press 20 is in operation, ink is transferred from the anilox roller 50 onto apexes (printing surfaces) of the halftone dot convexities 204 on the surface of the printing relief plate C, and then the ink is transferred to a print medium 54 such as a corrugated cardboard material or the like, which is gripped and fed between the plate cylinder 46 on which the printing relief plate C is mounted and the impression cylinder 52, thereby producing a print P on which images made up of halftone dots are formed.

FIG. 3 schematically shows in cross section an example of the printing relief plate C according to the present embodiment. As shown in FIG. 3, the printing relief plate C, in a condition of being disposed on an outer circumferential surface of the plate cylinder 46, includes a solid area 200, which is positioned maximally outward in a radial direction, a bottom area 202, which is disposed at the bottom of a lowermost recess formed radially inward from the solid area 200 by laser engraving, and halftone dot convexities 204, which are engraved into frustoconical shapes by laser engraving and which project radially outward from the bottom area 202. Among the halftone dot convexities 204, i.e., among halftone dot convexities 204 that make up a later-described halftone dot block (also referred to as a halftone dot section) and which reside within a screen tint region A having the same halftone dot area ratio Har, halftone dot convexities 204 having a highest halftone dot convexity height level Lh1 are referred to as “main halftone dot convexities” 204m.

The height difference Lh from the bottom area 202 of the solid area 200, where the halftone dot area ratio Har is Har=100%, has an actual value Lh=Lh200 (i.e., corresponding to a maximum depth Dmax of the depth data D), which resides in a range from about 100 to 200 μm with the height level of the bottom area 202 being taken as a 0 [μm] level reference, although the actual value depends on the material used for the flexographic printing plate material.

The halftone dot convexities 204 shown in FIG. 3 comprise printing surfaces (apexes of the halftone dot convexities 204), the heights of which are grouped into a plurality (three shown in FIG. 3) of levels (i.e., convexity height levels Lh1, Lh2, and Lh3, where Lh1>Lh2>Lh3), in a screen tint area A of the same halftone dot area ratio Har.

Among such halftone dot convexities 204 that constitute the screen tint region A having the same halftone dot area ratio Har, halftone dot convexities 204 having a maximum halftone dot height level Lh1 (or a depth level D1 from the solid area 200) are referred to in the present specification as main halftone dot convexities 204m, as described above. In FIG. 3, three main halftone dot convexities 204m are depicted.

In addition, in the example of the printing relief plate C shown in FIG. 3, apart from the main halftone dot convexities 204m the height of which is of the maximum height level, one halftone dot convexity 204s the height of which is of a next highest halftone dot height level Lh2 (Lh2<Lh1; and with a depth level D2, where D2>D1), and two halftone dot convexities 204t the height of which is of the lowest halftone dot height level Lh3 (Lh3<Lh2<Lh1; and with a depth level D3, where D3>D2>D1) are depicted.

Referring once again to FIG. 1, among the components making up the platemaking system 10, major components according to the present invention include the screening processor 14 and the halftone dot convexity height level determiner 16, which perform a computer-executed sequence (i.e., a data processing sequence performed when a CPU executes a program). The explanations below shall focus principally on the arrangement and processing details of the screening processor 14 and the halftone dot convexity height level determiner 16. For the most part, remaining components of the platemaking system 10 are known from Japanese Laid-Open Patent Publication No. 2008-230195, Japanese Laid-Open Patent Publication No. 2008-183888, Japanese Laid-Open Patent Publication No. 2007-185917, and Japanese Laid-Open Patent Publication No. 2006-095931, and thus such features will not be described in detail below.

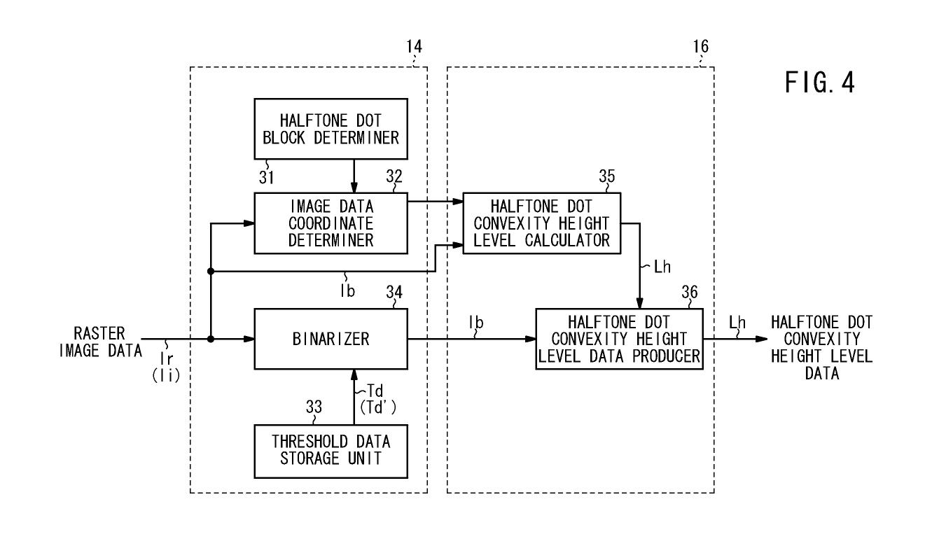

FIG. 4 is a functional block diagram showing the detailed structure (functions) of the screening processor 14 and the halftone dot convexity height level determiner 16.

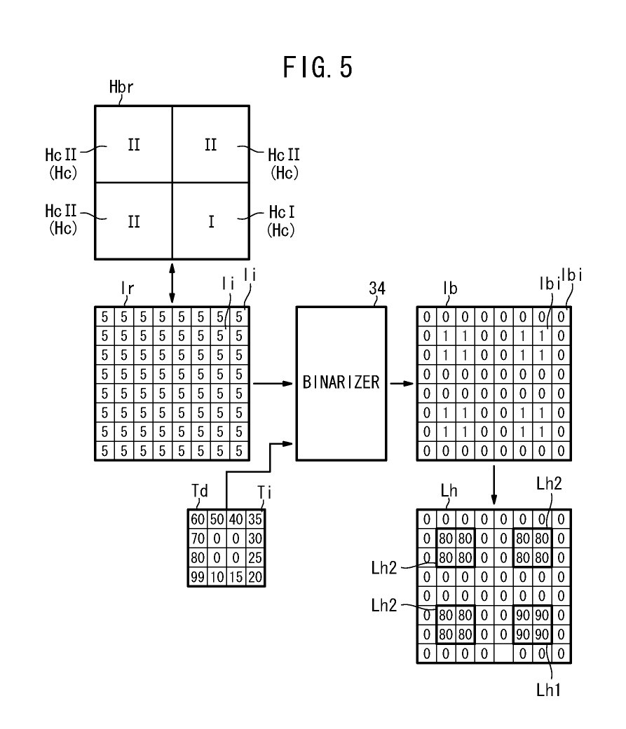

FIG. 5 is an explanatory diagram of numerical values for explaining operations of the screening processor 14 and the halftone dot convexity height level determiner 16.

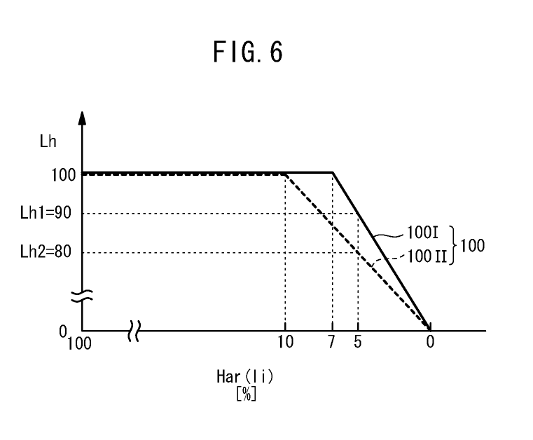

FIG. 6 is a diagram of conversion characteristics set in a halftone dot convexity height level calculator 35 shown in FIG. 4, by use of which image data Ii is converted into halftone dot convexity height level data Lh.

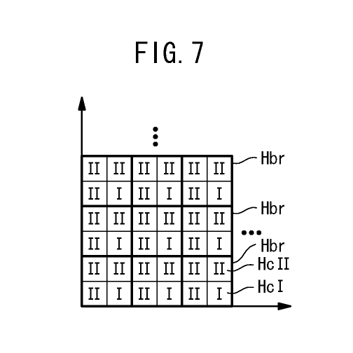

FIG. 7 is an explanatory drawing showing a repetitive arrangement pattern of halftone dot blocks Hbr.

As shown in FIGS. 4 and 5, a threshold data storage unit 33 of the screening processor 14 stores threshold data (threshold matrix) Td in the form of a matrix of thresholds Ti ranging from 1 to 99.

A binarizer 34 of the screening processor 14 compares respective image data (pixel data) Ii (0≦Ii≦100) of the raster image data Ir with thresholds Ti (0≦Ti≦99) of the threshold data Td read from the threshold data storage unit 33, and generates binary image data Ibi of binary image data Ib, each of which has a value of 0 or a value of 1, according to the following formula.

Ii≦Ti→0, Ii>Ti→1 (1)

In the present embodiment, as described above, the image data Ii are represented by halftone dot area ratios Har in a range from 0% to 100%. Among the halftone dot area ratios Har in the range from 0% to 100%, halftone dot area ratios Har in a range from about 0% to 10% correspond to a highlight gradation area of the image, halftone dot area ratios Har in a range from about 10% to 99% correspond to an intermediate gradation area of the image, and a halftone dot area ratio Har of 100% corresponds to a solid area of the image. Generally, halftone dot convexities 204, which are created for the highlight gradation area of the image, may be referred to as small dots (or small screen dots).

A halftone dot block determiner 31 determines how many sections (number of units) of halftone cells Hc are used to form one halftone dot block Hbr, which forms a processing unit within the screen tint region A of the same halftone dot area ratio Har, on the printing relief plate C or in the binary data Ib corresponding to the printing relief plate C, and in addition, determines how many levels (in the present embodiment, as discussed later, either two levels including level I and level II, or three levels including levels I, II and III) of halftone dot convexity height levels Lh are to be adopted within a single halftone dot block Hbr for heights of the printing surfaces of the halftone dot convexities 204 that are formed corresponding to the halftone dot cells Hc. (The halftone dot convexities 204, in the case of AM halftone dots, each correspond to one halftone dot cell Hc and are formed individually. Below, AM halftone dots shall be explained as an example in greater detail.) Furthermore, the halftone dot block determiner 31 lays out an arrangement pattern in which it is determined, from among a plurality of halftone dot height levels Lh, which levels of the halftone dot convexity height levels Lh are to be adopted for the halftone dot convexities 204 that are formed and correspond to each of the halftone dot cells Hc.

In the example shown in FIG. 5, one first halftone dot cell HcI of a halftone dot convexity height level Lh1, and three second halftone dot cells HcII of a halftone dot convexity height level Lh2 (Lh1>Lh2) are allocated with respect to a single halftone dot block Hbr made up from 2×2 halftone dot convexities.

The size of one halftone dot cell Hc is of a size equal to the size of the threshold data Td. As described above, one halftone dot convexity 204 is formed corresponding to one halftone dot cell Hc.

Ordinarily, the halftone dot block Hbr is formed by n² halftone dot cells (where n is an integer value of 2 or greater).

### First Embodiment

In the first embodiment, as noted above, one halftone dot block Hbr is formed from four halftone dot cells Hc of a 2×2 array (see FIG. 5). The halftone dot cells Hc are made up from two types of halftone dot cells (one first halftone dot cell HcI, and three second halftone dot cells HCII), in which levels (a plurality of levels) of heights of the printing surfaces of the halftone dot convexities 204, which are formed corresponding to positions of the respective halftone dot cells Hc, differ from one another, the halftone dot area ratio Har being of a fixed value, for example, a value of 10% or less, corresponding to the highlight gradation.

Stated otherwise, with the halftone dot block Hbr in the example of FIG. 5, which is constructed from 2×2 halftone dot cells Hc, one halftone dot block Hbr is made up from one first halftone dot cell HcI, which is arranged at the lower right, and three second halftone dot cells HcII, which are arranged at the upper right, upper left, and lower left in the halftone dot block Hbr.

As shown by the conversion characteristic drawing of FIG. 6, according to a first conversion characteristic curve 1001 applied to the first halftone dot cell HcI, height levels (halftone dot convexity height levels) Lh of the halftone dot convexities 204 are converted and determined so as to change over a range from a halftone dot convexity height level of Lh=0 (relative value) to a halftone dot convexity height level Lh=100 (maximum relative value) corresponding to a change of the halftone dot area ratio Har (image data Ii) between 0% to 7%, and so that the halftone dot convexity height level Lh is preserved at Lh=100 between halftone dot area ratios Har (image data Ii) of 7% to 100%.

On the other hand, according to a second conversion characteristic curve 100II applied to the second halftone dot cells HcII, height levels (halftone dot convexity height levels) Lh of the halftone dot convexities 204 are converted and determined so as to change over a range from a halftone dot convexity height level of Lh=0 (relative value) to a halftone dot convexity height level Lh=100 (maximum relative value) corresponding to a change of the halftone dot area ratio Har (image data Ii) between 0% to 10%, and so that the halftone dot convexity height level Lh is preserved at Lh=100 between halftone dot area ratios Har (image data Ii) of 10% to 100%.

In this manner, the conversion characteristic curves 100 between the halftone dot area ratio Har (image data Ii) and the halftone dot convexity height level L are made up from the first conversion characteristic curve 100I and the second conversion characteristic curve 100II. In addition, as noted above, the first conversion characteristic curve 100I is applied to the first halftone dot cell HcI in the halftone dot block Hbr shown in FIG. 5, whereas the second conversion characteristic curve 100II is applied to the second halftone dot cells HcII.

The conversion characteristic curves 100 can be stored either in a table or as numerical formulas.

As shown in FIG. 5, a portion of the raster image data Ir is constructed respectively from image data (pixel data) Ii of an 8×8 pixel region made up from pixels having the same halftone dot area ratio Har of “5”.

The size of the image data Ir is sectioned into regions having the same size as the halftone dot block Hbr (i.e., the same as the size of four halftone dot cells Hc), and processing is carried out on the image data Ir at a unit size of the halftone dot block Hbr.

In the binary processing performed by the binarizer 34, the threshold data Td, which is made up from 4×4 threshold values Ti, are compared in size with 4×4 image data portions Ii corresponding to the image data Ir made up from 4×4 image data Ii of a size corresponding to the respective halftone dot cells HcI, HcII. In addition, image data Ir (8×8 image data Ii) equal in size to the halftone dot block Hbr are converted into binary image data Ib (i.e., four portions of 4×4 binary image data Ibi), to which values of 0 or 1 are adopted, corresponding to the four halftone dot cells Hc (refer to the above equation (1)).

In this manner, binary image data Ib converted by the binarizer 34 is further converted into halftone dot convexity height level data Lh by a halftone dot convexity height level data producer 36.

In this case, by means of an image data coordinate determiner 32, it is determined to which halftone dot cell Hc position (coordinates) in the halftone dot block Hbr, and to which position (coordinates) within the halftone dot cell Hc, the image data Ii positions in the raster image data Ir should be positioned.

Additionally, in the halftone dot convexity height level calculator 35, the image data Ibi having values of “1” in the binary image data Ib shown in FIG. 5 are converted while the conversion characteristic curves 100I, 100II shown in FIG. 5 are referred to. More specifically, at the first halftone dot cell HcI of (Hbr, Ii, Ibi)=(HcI, 5, 1), while referring to the first conversion characteristic curve 100I, the halftone dot convexity height levels Lh are set such that Lh=Lh1=90, whereas at the three remaining second halftone dot cells HcII of (Hbr, Ii, Ibi)=(HcII, 5, 1), while referring to the second conversion characteristic curve 100II, the halftone dot convexity height levels Lh are set such that Lh=Lh2=80. Further, at locations where the value of the image data is “0”, the halftone dot convexity height levels Lh are set such that Lh=0.

In this manner, the raster image data Ir having the same halftone dot area ratio Har, as shown in the righthand middle portion of FIG. 5, is converted into halftone dot convexity height level data Lh (in the reference characters, Lh is also used to indicate the halftone dot convexity height level data), which is shown at the righthand lower position in FIG. 5.

Based on the halftone dot convexity height level data Lh, in the printing relief plate producer 18 shown in FIG. 1, at a portion corresponding to the halftone dot cell HcI, a region made up of four adjacent pixels in which Lh1=90 is defined by main halftone dot convexities 204m (see FIG. 3) having one halftone dot convexity height level Lh=Lh1=90, whereas at remaining portions corresponding to the halftone dot cells HcII, regions made up of four adjacent pixels in which Lh=80 are defined respectively by halftone dot convexities 204s (see FIG. 3) having one halftone dot convexity height level Lh=Lh2=80.

FIG. 7 is an explanatory drawing showing an image of a repetitive arrangement pattern of halftone dot blocks Hbr corresponding to an area in which the region of the raster image data Ir shown in FIG. 5 having the same halftone dot area ratio Har is arrayed repeatedly in horizontal and vertical directions.

When carried out in the foregoing manner, a printing relief plate C in which the heights of printing surfaces of the halftone dot convexities 204 to which ink is applied are set at a plurality (two according to the first embodiment) of height levels within a screen tint region A having the same halftone dot area ratio Har can be produced.

To continue with explanations concerning the producing of the printing relief plate C, when halftone dot convexity height level data Lh, which is determined by the halftone dot convexity height level determiner 16, are sent to and received by the printing relief plate producer 18, the depth data converter 18a of the printing relief plate producer 18 converts the halftone dot convexity height level data Lh into corresponding depth data D (see FIG. 3).

Then, based on the depth data D, the engraving CTP system 18b carries out a laser engraving process with respect to a flexographic printing plate material F, thereby producing a printing relief plate C having a plurality of halftone dot convexities 204 as well as a solid area 200.

FIG. 8 is a plan view showing in outline the structure of a laser engraving machine 60, which constitutes an engraving CTP system 18b for producing a printing relief plate C.

The laser engraving machine 60 includes an exposure head 62. The exposure head 62 is equipped with a focused position changing mechanism 64, and an intermittent feeding mechanism 66 operative in an auxiliary scanning direction AS.

The focused position changing mechanism 64 includes a motor 70 and a ball screw 71 for moving the exposure head 62 toward and away from the surface of a drum 68 on which a flexographic printing plate material F is mounted. The focused position of the laser beam L can be moved under the control of the motor 70.

The intermittent feeding mechanism 66 moves a stage 72 with the exposure head 62 mounted thereon in the auxiliary scanning direction AS, and has a ball screw 74 and an auxiliary scanning motor 76 for rotating the ball screw 74 about its axis. Under the control of the auxiliary scanning motor 76, the exposure head 62 can be moved intermittently along an axis 78 of the drum 68.

A flexographic printing plate material F is secured to the drum 68 by a chuck 80, which is located in a position not exposed to the laser beam L emitted from the exposure head 62. While the drum 68 rotates in the direction of the arrow, the exposure head 62 applies the laser beam L with respect to the flexographic printing plate material F on the rotating drum 68, for thereby performing laser engraving to form halftone dot convexities 204 on the surface of the flexographic printing plate material F. Upon continued rotation of the drum 68, when the chuck 80 passes in front of the exposure head 62, the exposure head 62 is intermittently fed along the auxiliary scanning direction AS, whereupon a laser engraving process is performed along a next scanning line.

While the flexographic printing plate material F is moved along the main scanning direction MS upon rotation of the drum 68, and while the exposure head 62 is fed intermittently along the auxiliary scanning direction AS, the exposure operation position (i.e., the focused position of the laser beam L on the flexographic printing plate material F) is controlled. Also, based on the depth data D at each exposure operation position, the intensity and ON/OFF of the laser beam L is controlled, so as to laser engrave the halftone dot convexities 204, thereby forming a relief of a desired shape on the principal surface of the flexographic printing plate material F.

The flexographic printing plate material F including halftone dot convexities 204 formed thereon is produced as a printing relief plate C, which is then mounted in the aforementioned flexographic printing press 20.

In the flexographic printing press 20, as shown in FIG. 2, the anilox roller 50 transfers ink to apexes (printing surfaces) of the halftone dot convexities (halftone dot printing convexities) 204, which are formed on the surface of the printing relief plate C. The ink is squeezed between the plate cylinder 46, on which the printing relief plate C is mounted, and the impression cylinder 52, whereupon the ink is transferred to the print medium 54, such as a corrugated cardboard material or the like, which is fed in the direction of the arrow, thereby producing a print P on which an image made up of halftone dots is formed.

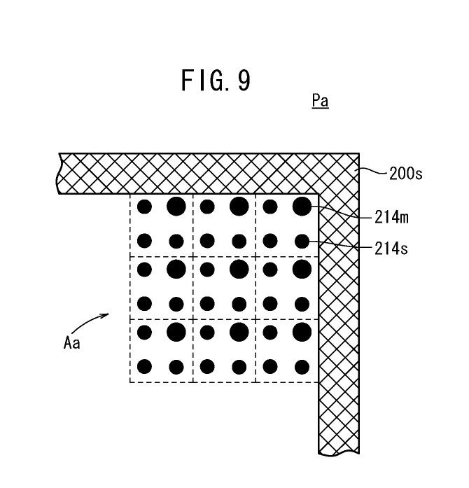

FIG. 9 is a view showing an image formed on a print Pa as an applied example of the present embodiment. Such an image is constituted from an image of a solid area 200s shown in crosshatching, which is formed by the solid area 200 (see FIG. 3), and an image of a screen tint region Aa of the same percentage, i.e., in which the halftone dot area ratio Har thereof is 10% or below.

In the example of FIG. 9, the image of the screen tint region Aa in which the halftone dot area ratio Har is of the same percentage, as described with reference to the printing relief plate C of FIG. 3, is constituted by a regular arrangement made up from main halftone dots 214m, which are printed by the main halftone dot convexities 204m having the halftone dot height level Lh1 (see also FIG. 5) of which the height thereof is of the highest level, and halftone dots 214s, which are printed by the halftone dot convexities 204s having the halftone dot height levels Lh2 (see also FIG. 5) of which the height thereof is of the next highest level. In this case, the printing relief plate C also has sections, i.e., regions of the halftone dot blocks Hbr (see FIG. 7) in which the heights of the main halftone dot convexity 204m and the halftone dot convexities 204s, which are formed adjacent to each other, are of different levels within a screen tint region for printing the screen tint region Aa.

In this manner, a print Pa can be made in which, within the screen tint region Aa corresponding to highlight gradations of an image, localized thickening of the main halftone dots 214m and the halftone dots 214s can be avoided, and generation of printing defects near the solid area 200s can be reduced or eliminated owing to the arrangement of the main halftone dots 214m.

### Second Embodiment

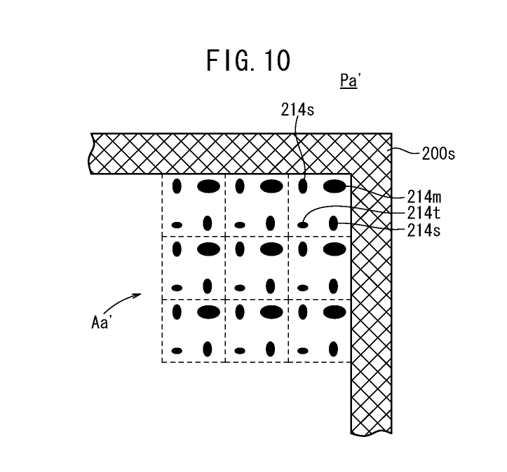

In place of the example of FIG. 9, as shown in the print Pa′ of FIG. 10, the image of the screen tint region Aa′ in which the halftone dot area ratio Har is of the same percentage, as described with reference to the printing relief plate C of FIG. 3, may be constituted by a regular arrangement made up from main halftone dots 214m, which are printed by the main halftone dot convexities 204m having the halftone dot height level Lh1 of which the height thereof is of the highest level, halftone dots 214s, which are printed by the halftone dot convexities 204s having the halftone dot height levels Lh2 of which the height thereof is of the next highest level, and halftone dots 214t, which are printed by the halftone dot convexities 204t having the halftone dot height levels Lh3 of which the height thereof is of the lowest level.

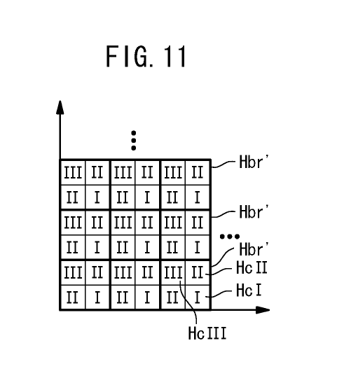

In the example of FIG. 10, the screen tint region of the printing relief plate C is defined by a repeated arrangement of sections (regions) of halftone dot blocks Hbr′ as shown in FIG. 11. Concerning the halftone dot cells Hc, three types of halftone dot cells of different heights (i.e., one first halftone dot cell HcI, two second halftone dot cells HcII, and one third halftone dot cell HcIII) are used.

### Third Embodiment

Next, an example of processing of the halftone dot convexity height level data Lh, which is performed by the halftone dot convexity height level determiner 16 when halftone dot cells (first halftone dot cells HcI, second halftone dot cells HcII, and third halftone dot cells HcIII) that differ in height are used, shall be described below in detail.

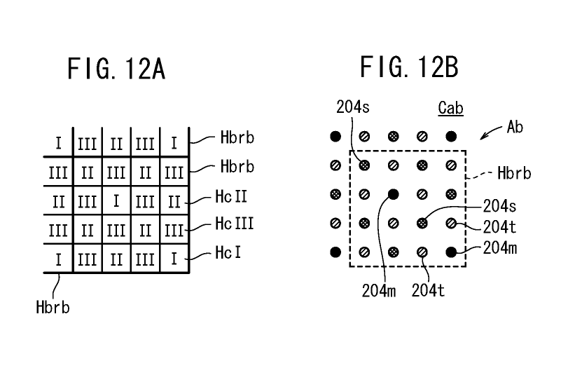

FIG. 12A shows an arrangement pattern of a halftone dot block Hbrb made up from sixteen halftone dot cells Hc (first through third halftone dot cells HcI, HcII, and HcIII) arranged in a 4×4 array.

FIG. 12B shows schematically a basic pattern (generalized expression) of a printing relief plate Cab making up a screen tint region Ab having the same halftone dot area ratio Har, which is formed corresponding to the halftone dot block Hbrb shown in FIG. 12A. The square shaped portion surrounded by the broken line also is referred to as a halftone dot block Hbrb.

Referring to the halftone dot blocks Hbrb of FIGS. 12A and 12B, main halftone dot convexities 204m (shown by solid black circles) are formed at positions corresponding to the main halftone dot cells HcI, halftone dot convexities 204s (shown by crosshatching within circles) are formed at positions corresponding to the halftone dot cells HcII, and halftone dot convexities 204t (shown by hatching within circles) are formed at positions corresponding to the halftone dot cells HcIII.

An exemplary method of determining the halftone dot convexity height levels Lh of the main halftone dot convexities 204m, the halftone dot convexities 204s, and the halftone dot convexities 204t, which are formed on the printing relief plate C corresponding to the first through third halftone dot cells HcI, HcII and HCIII, shall be described next.

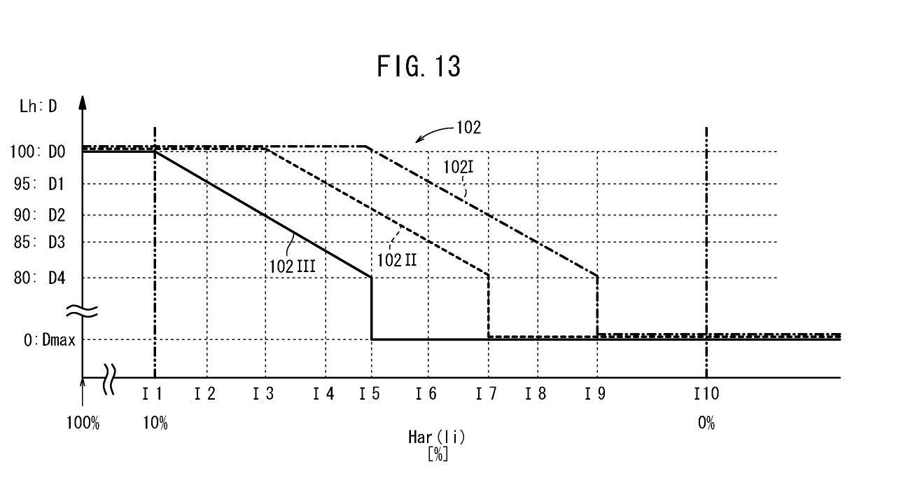

FIG. 13 shows conversion characteristic curves 102 between halftone dot area ratios Har and halftone dot convexity height levels Lh, which are applied to the halftone dot block Hbrb in the example of FIG. 12A. As noted above, the conversion characteristic curves 102 are stored in the halftone dot convexity height level calculator 35.

The conversion characteristic curves 102 are made up from a first conversion characteristic curve 102I, a second conversion characteristic curve 102II, and a third conversion characteristic curve 102III.

The first through third conversion characteristic curves 102I, 102II and 102III are applied, respectively, corresponding to the first through third halftone dot cells HcI, HcII, and HcIII.

The horizontal axis of the first through third conversion characteristic curves 102I, 102II and 102III represents halftone dot area ratios Har of the image data Ii, and the vertical axis represents halftone dot convexity height levels Lh together with depth data D corresponding to such halftone dot convexity height levels Lh. The depth data D is indicative of a reduction in layer thickness amount (i.e., an engraving depth amount) performed by the laser engraving machine 60 on the flexographic printing plate material F. This implies that the halftone dot convexity height levels Lh can similarly be used as indicative of an engraving height amount.

Concerning the halftone dot convexity height levels Lh, the solid area is set at “100”, where the value Lh=100 corresponds to a value of the data D=D0=0 μm. Included therewith, the halftone dot convexity levels Lh are divided into five levels (five steps).

The relation between the halftone dot convexity levels Lh and the characters of the depth data D, together with the relation between the depth data D and the actual depth level (expressed in μm), is as follows:

Lh=100:D=D0→D0=0 μm

Lh=95:D=D1→D1=5 μm

Lh=90:D=D2→D2=10 μm

Lh=85:D=D3→D3=15 μm

Lh=80:D=D4→D4=20 μm

80>Lh≧0→D≈suitable values within 100 to 200 μm

As shown in FIG. 13, the halftone dot height level Lh, which is an engraving height with respect to the halftone dot area ratio Har, i.e., a halftone dot area ratio Har of a certain gradation value, corresponding to the total highlight gradation region at which the screen dot area ratio Har is of a degree from 0% to 10%, is determined so as to become lower gradually in order of the halftone dot cells HcI, HcII, HcIII, whereby a smooth gradation expression with very few tone jumps can be realized.

Further, within the entire highlight gradation region, for each of the halftone dot cells HcI, HcII, HcIII, by setting the halftone dot height level Lh to become higher continuously substantially in parallel, as shown by the first through third conversion characteristic curves 102I, 102II and 102III, and corresponding to an increase of the halftone dot area ratio Har, a superior high quality pattern can be realized, in which peculiar periodic patterns are not conspicuous on the printed image.

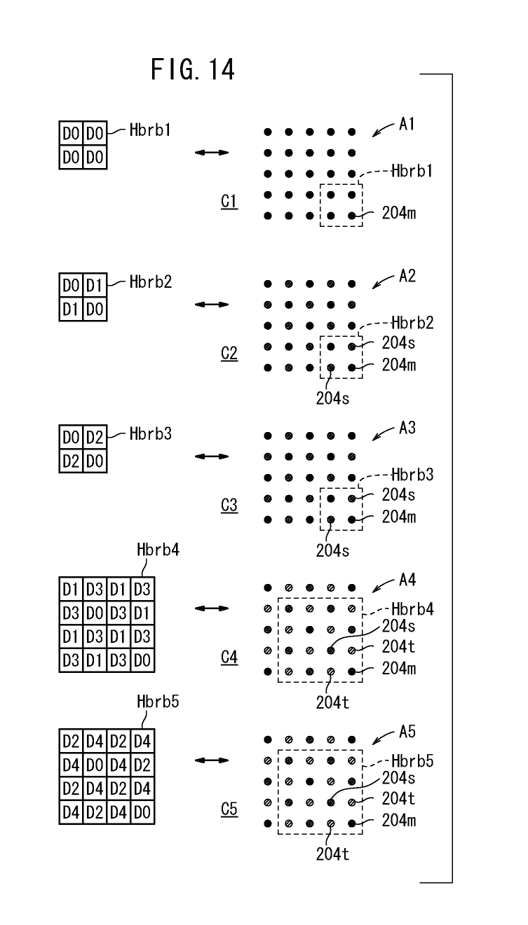

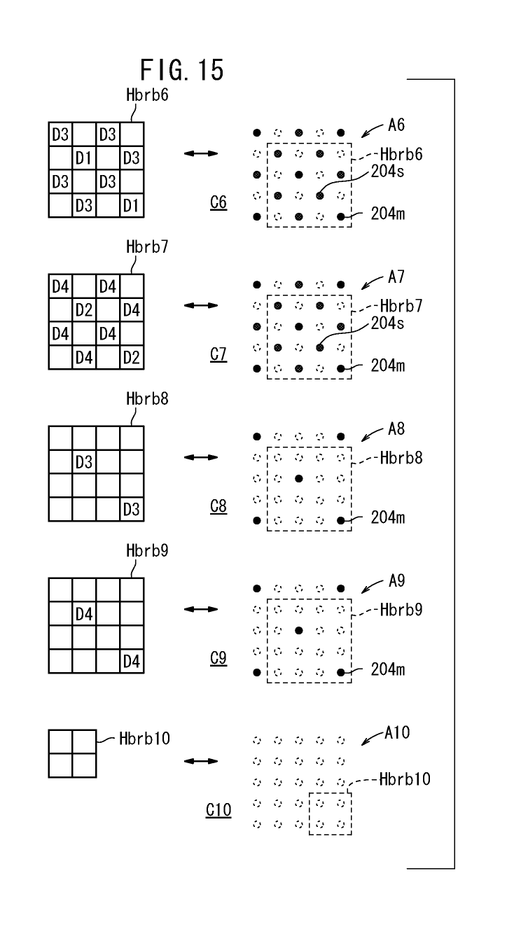

FIGS. 14 and 15 show halftone dot blocks Hbrb1 to Hbrb10 formed on the basis of periodic patterns in respective halftone dot area ratios Har for which the image data Ii=I1 to I10, which are determined based on settings of the halftone dot blocks Hbrb of FIG. 12A and the conversion characteristic curves 102 (102I, 102II, 102III) of FIG. 13, and arrangement patterns on printing relief plates C1 to C10 having screen tint regions A1 to A10 of the same halftone dot area ratio Har, which are formed by the halftone dot blocks Hbrb1 to Hbrb10.

For example, to describe the halftone block Hbrb5, in a condition where the image data Ii of FIG. 13 is such that Ii=15, the convexity height level Lh is determined such that {Lh=100, D=D0 (main halftone dot convexity 204m)}, {Lh=90, D=D2 (halftone dot convexity 204s)}, {Lh=80, D=D4 (halftone dot convexity 204t)}. Further, by referring to the arrangements of the first through third halftone dot cells HcI, HcII, and HcIII of the halftone dot block Hbrb of FIG. 12A, as shown in FIG. 14, it can be understood that the halftone dot convexity levels Lh of the halftone dot block Hbrb5 also are determined {in FIG. 14, to facilitate understanding, depth data D (D=D0, D2, D4) are shown}. Sixteen halftone dot convexities, which correspond to the sixteen (4×4) unit halftone dot block Hbrb5 of FIG. 14, are arrayed with reference to the lower right position on the printing relief plate C5 of FIG. 14 (the same convention is applied in the descriptions below). More specifically, although the halftone dot block Hbrb5 actually is a 4×4 matrix, in the examples on the righthand side of FIG. 14, for example, on the printing relief plate C5, twenty-five (5×5) individual halftone dot convexities 204 are drawn, including portions of three other intended halftone dot blocks Hbrb5, which are laid out on an upper side, left side, and a left-upper side of the illustrated halftone dot block Hbrb5, which is made up from sixteen (4×4) halftone dot convexities 204 surrounded by the square shaped broken line of the screen tint region AS (a similar convention is adopted for other descriptions hereinbelow). Drawing was done in this way, i.e., as twenty-five (5×5) halftone dot convexities 204, principally to enable expression (understanding) of the dispersion arrangement of the main halftone dot convexities 204m.

Based on the arrangement of the depth data D (or the halftone dot convexity height data Lh) of the halftone dot block Hbrb5, the main halftone dot convexities 204m (shown as solid black points, here as well as in the descriptions below), the halftone dot convexities 204s (shown in double hatching, here as well as in the descriptions below), and the halftone dot convexities 204t (shown in hatching, here as well as in the descriptions below) are formed on the printing relief plate C5.

As another example, to describe the halftone block Hbrb6 of FIG. 15, in a condition where the image data Ii of FIG. 13 is such that Ii=16, the convexity height level Lh is determined such that {Lh=95, D=D1 (main halftone dot convexity 204m)}, {Lh=85, D=D3 (halftone dot convexity 204s)}, {Lh=0, D=Dmax (halftone dot convexities are not formed)}. Further, by referring to the arrangements of the first through third halftone dot cells HcI, HcII, and HcIII of the halftone dot block Hbrb of FIG. 12A, as shown in FIG. 15, it can be understood that the halftone dot convexity levels Lh of the halftone dot block Hbrb6 also are determined {in FIG. 15, to facilitate understanding, depth data D are shown}.

{Lh=0, D=Dmax} refers to the bottom area 202 (see FIG. 3). Therefore, setting of the maximum depth Dmax (see FIG. 3) implies that the positions of the corresponding third halftone dot cells HcIII (see FIG. 12A) in the halftone dot block Hbrb6 are left blank.

Based on the arrangement of the depth data D (or the halftone dot convexity height data Lh) of the halftone dot block Hbrb6, the main halftone dot convexities 204m, the halftone dot convexities 204s, and portions where halftone dot convexities are not formed, as shown by the broken line circles, are formed on the printing relief plate C6.

### First Modified Example of Third Embodiment

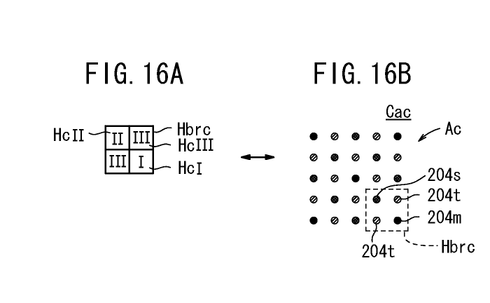

FIG. 16A shows an arrangement pattern of a halftone dot block Hbrc made up from halftone dot cells Hc (first through third halftone dot cells HcI, HcII, and HcII) arranged in a 2×2 array.

FIG. 16B shows schematically a basic pattern of a printing relief plate Cac making up a screen tint region Ac having the same halftone dot area ratio Har, which is formed corresponding to the halftone dot block Hbrc shown in FIG. 16A.

A main halftone dot convexity 204m is formed at a position corresponding to the main halftone dot cell HcII, a halftone dot convexity 204s is formed at a position corresponding to the halftone dot cell HcII, and two halftone dot convexities 204t are formed respectively at positions corresponding to the halftone dot cells HcIII.

In this case as well, halftone dot convexity height levels Lh are determined by referring to the conversion characteristic curves 102 (102I, 102II, 102III) shown in FIG. 13.

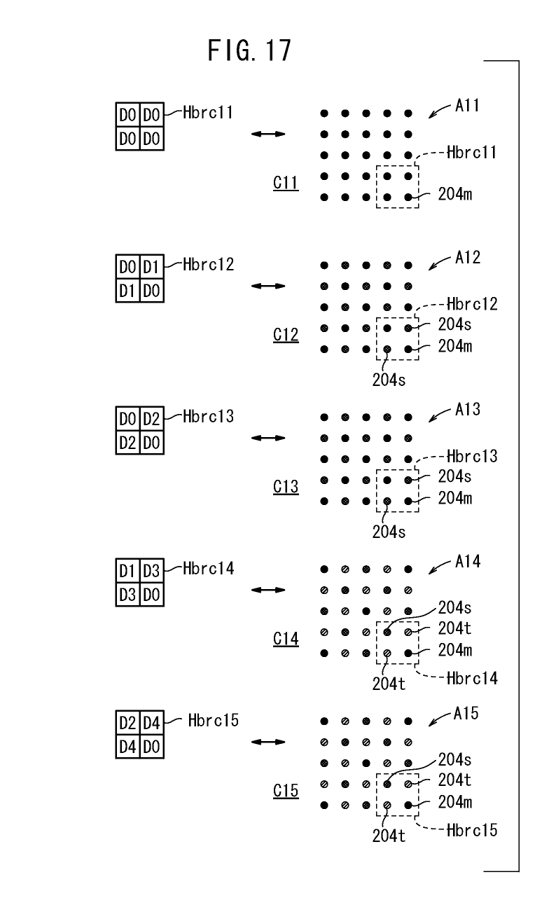

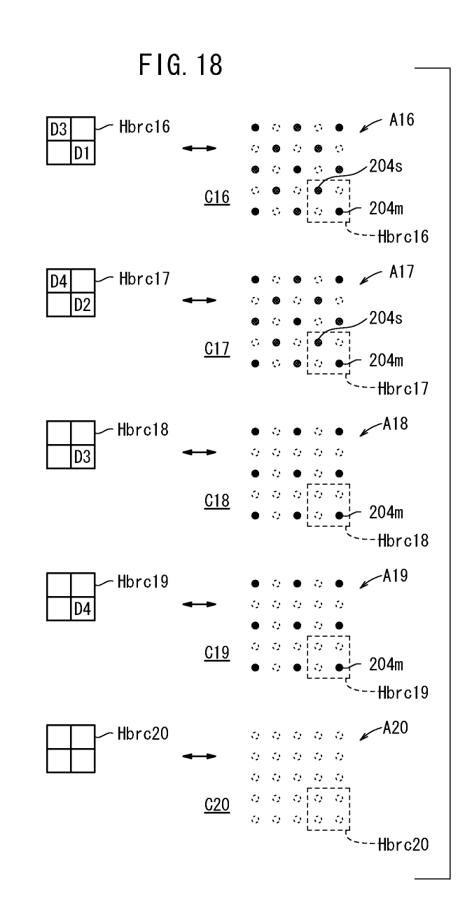

FIGS. 17 and 18 show halftone dot blocks Hbrc11 to Hbrc20 formed on the basis of periodic patterns in respective halftone dot area ratios Har for which the image data Ii=I1 to I10, which are determined based on settings of the halftone dot blocks Hbrc of FIG. 16A and the conversion characteristic curves 102 (102I, 102II, 102III) of FIG. 13, and arrangement patterns on printing relief plates C11 to C20 having screen tint regions A11 to A20 of the same halftone dot area ratio, which are formed by the halftone dot blocks Hbrc11 to Hbrc20.

### Second Modified Example of Third Embodiment

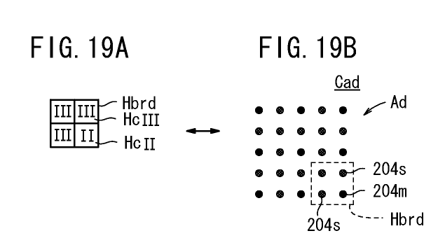

FIG. 19A shows an arrangement pattern of a halftone dot block Hbrd made up from halftone dot cells Hc (a halftone dot cell HcII, and halftone dot cells HcIII) arranged in a 2×2 array.

FIG. 19B shows schematically a basic pattern of a printing relief plate Cad making up a screen tint region Ad having the same halftone dot area ratio Har, which is printed corresponding to the halftone dot block Hbrd shown in FIG. 19A.

A main halftone dot convexity 204m is formed at a position corresponding to the halftone dot cell HcI (in this case, serving as a main halftone dot cell), and halftone dot convexities 204s are formed at positions corresponding to the halftone dot cells HcIII.

In this case as well, halftone dot convexity height levels Lh are determined by referring to the conversion characteristic curves 102 (102II, 102III) shown in FIG. 13.

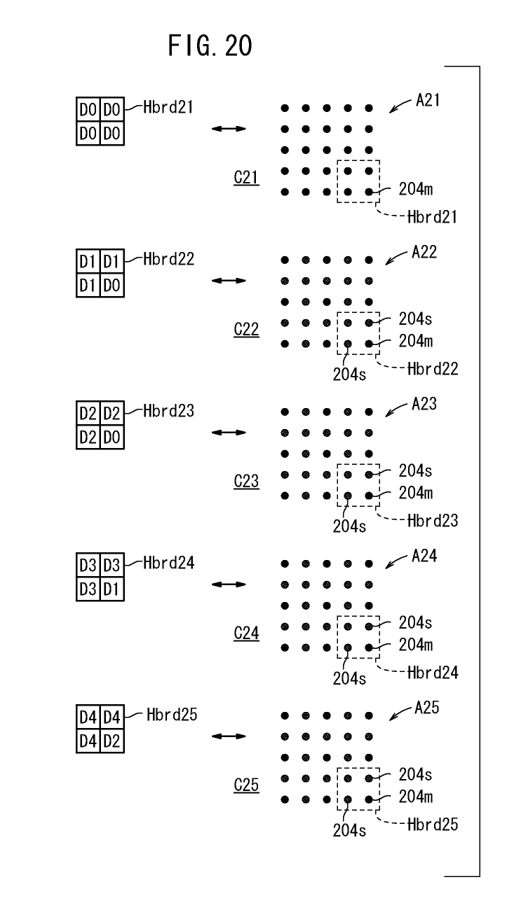

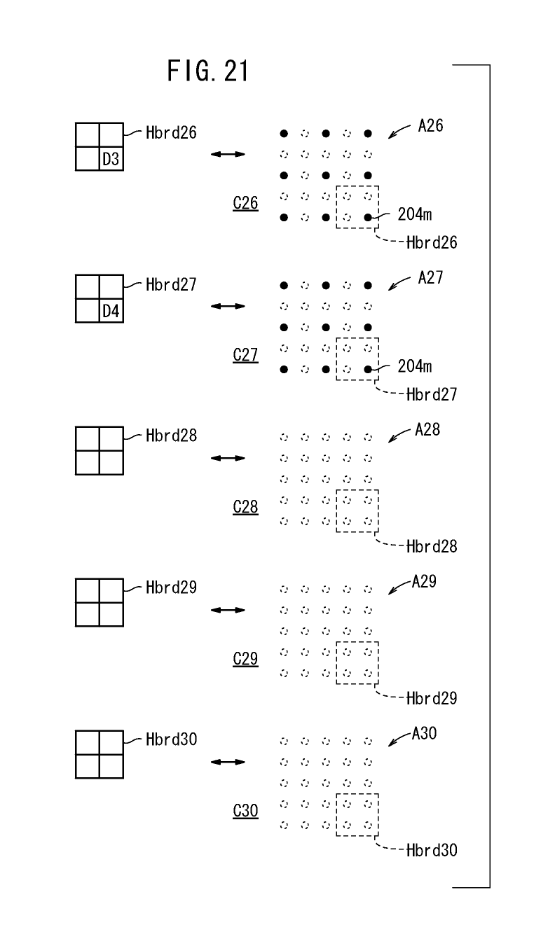

FIGS. 20 and 21 show halftone dot blocks Hbrd21 to Hbrd30 formed on the basis of periodic patterns in respective halftone dot area ratios Har for which the image data Ii=I1 to I10, which are determined based on settings of the halftone dot blocks Hbrd of FIG. 19A and the conversion characteristic curves 102 (102I, 102II, 102III) of FIG. 13, and arrangement patterns on printing relief plates C21 to C30 having screen tint regions A21 to A30 of the same halftone dot area ratio Har, which are formed by the halftone dot blocks Hbrd21 to Hbrd30.

### Outline Explanation of the Embodiments

As explained above, according to the aforementioned embodiments, a plurality of halftone dot convexities 204 (204m, 204s, 204t) for printing respective halftone dots 214 (214m, 214s, 214t) on a print medium 54 by transferring ink thereto are formed on the printing relief plate C. Heights of printing surfaces of the halftone dot convexities 204, which are formed adjacent to each other and to which ink is applied, include a plurality of halftone dot convexity height levels Lh (Lh1, Lh2, Lh3) within a region of the halftone dot area ratio Har, i.e., within a screen tint region in which halftone dot convexities 204 of the same halftone dot area ratio Har are formed side by side in a pattern for printing at a uniform density on a print, as shown by the screen tint areas A (FIG. 3), Aa (FIG. 9), Aa′ (FIG. 10), Ab (FIG. 12B), A1 through A30 (FIGS. 14, 15, 17, 18, 20 and 21), Ac (FIG. 16B), and Ad (FIG. 19B).

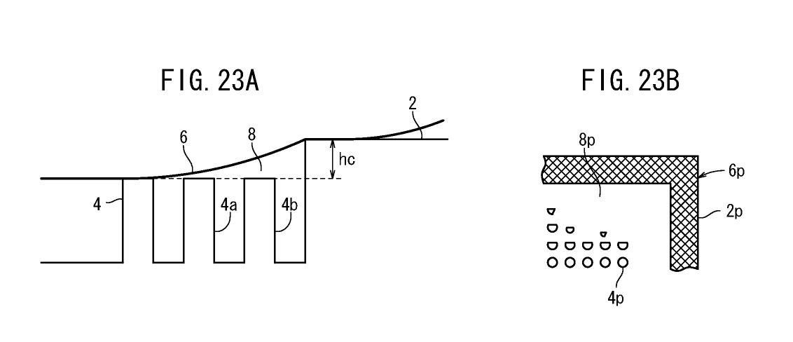

Additionally, for example, by making heights of the halftone dot convexities 204 in the vicinity of the solid area 200 to be of the same height or of a slightly lower height than the solid area 200 (see FIGS. 9 and 10), generation of printing defects in the vicinity of the solid area 2p, which was explained with reference to FIGS. 23A and 23B, can be reduced or eliminated.

Within a region of the same halftone dot area ratio Har, i.e., within a screen tint region, heights of the halftone dot convexities 204, which are formed adjacent to each other, are formed in at least three levels. Thus, more detailed control is enabled and an image quality having favorable graininess can be obtained on the print P.

In this case, within a region of the same halftone dot area ratio Har, i.e., within the screen tint region A, preferably, a difference in height between main halftone dot convexities 204m, the height of the printing surface of which is of a highest level, and halftone dot convexities 204t, the height of the printing surface of which is of a lowest level, is at least 15 μm. Then, even if engraving variances occur when the halftone dot convexities 204 are formed, such variances are on the order of 10 μm at a maximum, and differences in height in the plural halftone dot convexities 204 that constitute the screen tint region A of the same halftone dot area ratio Har can be provided certainly.

Further, within the region of the same halftone dot area ratio Har, i.e., within the screen tint region A, it has been understood experimentally that a density ratio at which the main halftone dot convexities 204m, the height of which is of a highest level, exist should preferably be equal to or greater than 5% and equal to or less than 50%. The density ratio at which the main halftone dot convexities exist, in the case it is considered to set such a density ratio digitally, preferably is set roughly at 1/16, ⅛, ¼, or ½.

Preferably, the arrangement of the main halftone dot convexities 204m is such that the main halftone dot convexities (204m) are arranged in a dispersed fashion within the region of the same halftone dot area ratio Har, i.e., within the screen tint region A.

For example, as shown in FIG. 12A, in the case of a 4×4 square matrix of halftone dot convexities 204 on the printing relief plate Cab (see FIG. 12B), the main halftone dot convexities 204m are dispersed at one vertex position (a vertex position in the lower right of the example of FIG. 12B) and at a position inside of the opposing vertex, on a diagonal line that passes between the one vertex position and the opposing vertex (in the example of FIG. 12B, among the four vertices of the halftone dot block Hbrb surrounded by the square shaped broken line, the vertex positioned to the left and upwardly of the halftone dot convexity 204s), which is opposite to the one vertex position (see FIG. 12B).

By being dispersively positioned in this manner, with the printing relief plate Cab, in the screen tint region Ab having the same halftone dot area ratio Har, when viewed macroscopically, the main halftone dot convexities 204m are dispersed on vertices of a square shaped lattice, as well as centrally therein.

As a result of the dispersed arrangement of the main halftone dot convexities 204m, the printing pressure is made uniform, and in particular, printing pressure instabilities caused by making highlight gradations lower in level can be reduced, and localized enlargement of small halftone dots, or so called small dots, can be avoided.

In this case, when the halftone dots are AM halftone dots, a distribution of centers of the main halftone dot convexities 204m forms a portion of a distribution of centers of the halftone dot convexities 204. Stated another way, the distribution of centers of the main halftone dot convexities 204m is a partial assemblage of an overall assemblage of centers of the halftone dot convexities 204. For example, in the halftone dot block Hbrb within the square shaped region of the broken lines in FIG. 12B, the centers of the halftone dot convexities 204 are sixteen in number, and thereamong, the centers of two main halftone dot convexities 204m are shared with the centers of the halftone dot convexities 204.

To explain in greater detail concerning the uniform dispersion arrangement, with the printing relief plate C within the screen tint region A having the same halftone dot area ratio Har, when viewed macroscopically, assuming that centers of the main halftone dot convexities 204m are distributed at vertices of a polygonal lattice, which is equilateral triangular shaped, square shaped, rectangular shaped, diamond shaped, parallelogram shaped, or regular hexagonal shaped, and wherein lengths of all sides or lengths of opposing sides of the polygonal lattice are equivalent, then the main halftone dot convexities 204m are dispersed uniformly. With a polygonal lattice, which is square shaped, rectangular shaped, or regular hexagonal shaped, in addition to being distributed at vertices, preferably, the centers of the main halftone dot convexities 204m are distributed at centers (centroids) thereof as well.

In this case, a positional error between center positions of the main halftone dot convexities 204m and positions of vertices of a regular polygonal lattice, the lengths of all sides of which are equal, is ½ or less of a minimum value of the lengths of each of the sides that form the regular polygonal lattice. As a result, the uniform dispersion of the main halftone dot convexities is not impaired.

In the above embodiments, concentrated halftone dots are employed according to a so-called dithering process, which are AM halftone dots (halftone dots according to an AM screen) in which one halftone dot is formed, the size (diameter) of which increases as the graduation value increases within each halftone dot cell Hc. However, distributed halftone dots may be employed, which are FM halftone dots (halftone dots according to an FM screen) in which halftone dots in a halftone dot cell Hc have a constant size (diameter), and wherein the density of the halftone dots in the halftone dot cell Hc increases as the graduation value increases.

If an FM screen is employed, then blue-noise mask threshold data Td′, comprising about 256×256 thresholds in which low-frequency components are removed as much as possible for the threshold data Td and dots of which are uniformly distributed, are stored in the threshold data storage unit 33. In addition, in the binarizer 34, the blue-noise mask threshold data Td′ may be compared with raster image data Ir of the same size, so as to be converted into binary image data Ib. Concerning the binary image data Ib, having been subjected to a blue-noise mask screening process, the halftone dot pattern, which indicates the arrangement of halftone dots, possesses a non-periodic radial symmetry, such that when the binary image data Ib is subjected to two-dimensional FFT (fast Fourier transform) processing and confirmed, in the power spectrum, low-frequency spectra having a spatial frequency in the vicinity of the 1.0 (0 to 5) c/mm for which human visual perception is high are few, and the power spectrum is concentrated in a spectrum having frequencies at or above a spatial frequency of 5 to 10 c/mm for which human visual perception is low.

Additionally, when the halftone dots are FM halftone dots, the distribution of centers of the main halftone dot convexities 204m is determined based on a distribution of centers of blue-noise FM halftone dots, which are formed by binary image data Ib converted using the blue-noise mask threshold data Td′. Thus, the main halftone dot convexities 204m are dispersed uniformly, graininess is not conspicuous, and generation of periodic patterns can be suppressed.

Next, explanations shall be made concerning preferred features when, within a screen tint region, a plurality of adjacent halftone dot convexities 204 form halftone dot blocks Hbrb (FIG. 12A), and an arrangement pattern of height levels of printing surfaces of the halftone dot convexities 204 within the halftone dot blocks Hbrb are repeated periodically, and the totality of the halftone dot convexities 204, i.e., the screen tint region, is formed thereby.

For example, as shown in FIGS. 12A and 12B, when the halftone dot blocks Hbrb are constructed from 4×4 halftone dot convexities 204, such that heights of the halftone dot convexities 204 are in three levels, the number of halftone dot convexities that make up the main halftone dot convexities 204m of a first-level height, the height of which is highest, is two in number, the number of halftone dot convexities 204s of a second-level height, which is next highest, is six in number, and the number of halftone dot convexities 204t of a third-level height, which is lowest, is eight in number, and at adjacent halftone dot blocks Hbrb having the same halftone dot convexity arrangement, sides of halftone dot convexities 204 of the same level are arranged so as not to be shared. As a result, smooth gradations with very few tone jumps can be achieved.

Similarly, as shown in FIGS. 16A and 16B, when the halftone dot blocks Hbrc are constructed from 2×2 halftone dot convexities 204 such that heights of the halftone dot convexities 204 are in three levels, the number of halftone dot convexities that make up the main halftone dot convexities 204m of a first-level height, the height of which is highest, is one in number, the number of halftone dot convexities 204s of a second-level height, which is next highest, is one in number, and the number of halftone dot convexities 204t of a third-level height, which is lowest, is two in number, and at adjacent halftone dot blocks Hbrc having the same halftone dot convexity arrangement, sides of halftone dot convexities 204 of the same level are arranged so as not to be shared. As a result, smooth gradations with very few tone jumps can be achieved.

Still further, as shown in FIGS. 19A and 19B, when the halftone dot blocks Hbrd are constructed from 2×2 halftone dot convexities 204 such that heights of the halftone dot convexities 204 are in two levels, the number of halftone dot convexities that make up the main halftone dot convexities 204m of a first-level height, the height of which is highest, is one in number, and the number of halftone dot convexities 204s of a second-level height, which is next highest, is three in number, and halftone dot blocks Hbrd having the same halftone dot convexity arrangement are arranged continuously. As a result, smooth gradations with very few tone jumps can be achieved.

In the foregoing manner, according to the above-described embodiments, because a plurality of heights of printing surfaces of the halftone dot convexities 204 to which ink is applied are provided on a printing relief plate C within a screen tint region A having the same halftone dot area ratio Har, and more specifically, because on the printing relief plate C, on which there are formed a plurality of halftone dot convexities 204, which are provided on a surface of a flexographic printing plate material F for printing respective halftone dots 214 by transferring ink to a print medium 54, the screen tint region A is divided into halftone dot blocks (halftone dot sections) Hbr, which are formed from a plurality of adjacent halftone dot convexities 204, and since height levels of the halftone dot convexities 204 that form the halftone dot blocks Hbr are set at different height levels, localized thickening of small halftone dots can be avoided, generation of printing defects near a solid area can be resolved, and instabilities in printing pressure caused by making heights of the halftone dot convexities 204 lower in level can also be reduced.

The present invention is not limited to the above-described embodiments, and it is a matter of course that various alternative or additional structures could be adopted based on the content of the present specification. For example, in the above embodiments, halftone dots the screen angle of which is 0 degrees have been illustrated. However, it is known in the art that for performing color printing with relief plates, such as flexographic printing, 0-degree halftone dots are used, the C, M, Y, K screen angles of which are 0 degrees, 15 degrees, 45 degrees, and 75 degrees. Alternatively, 7.5-degree-shifted halftone dots may be used, the C, M, Y, K screen angles of which are 7.5 degrees, 22.5 degrees, 52.5 degrees, and 82.5 degrees. According to the present invention, halftone dots having screen angles other than 0 degrees are capable of achieving a print quality having better gradation, and which is free of defects such as irregularities.

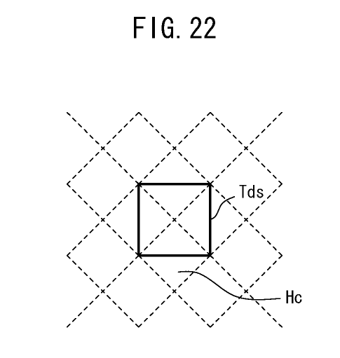

Also, for halftone dots the screen angle of which is not 0 degrees, but rather is 15 degrees, 45 degrees, 75 degrees, 7.5 degrees, 22.5 degrees, 52.5 degrees, or 82.5 degrees, the size of the halftone dot cell Hc and the size of the threshold data Td may not be identical to each other. Rather, in an example in which the screen angle is 45 degrees, as shown in FIG. 22, the threshold data Td may comprise threshold data Tds of one large super cell, which corresponds to a plurality of halftone dot cells Hc (two halftone dot cells Hc in FIG. 22).

Although certain preferred embodiments of the present invention have been shown and described in detail, it should be understood that various changes and modifications may be made to the embodiments without departing from the scope of the invention as set forth in the appended claims.

What is claimed is:

1. A printing relief plate having a plurality of halftone dot convexities disposed on a surface of a plate material, for printing halftone dots on a print medium by transferring ink to the print medium,
the printing relief plate comprising the halftone dot convexities formed adjacent to each other and having height levels that differ within a screen tint region.

2. The printing relief plate according to claim 1, wherein heights of the halftone dot convexities, which are formed adjacent to each other with differing height levels, include at least three levels.

3. The printing relief plate according to claim 1, wherein in case that the halftone dot convexities, which are formed adjacent to each other with differing height levels, are formed from four halftone dot convexities, among heights of the four halftone dot convexities, a difference in height between a main halftone dot convexity the height of which is of a highest level and a halftone dot convexity the height of which is of a lowest level is at least 15 μm.

4. The printing relief plate according to claim 1, wherein, among the halftone dot convexities, which are formed adjacent to each other with differing height levels, a density ratio at which main halftone dot convexities the height of which is of a highest level exist is equal to or greater than 5% and equal to or less than 50%.

5. The printing relief plate according to claim 4, wherein within the screen tint region, the main halftone dot convexities are arranged in a dispersed fashion.

6. The printing relief plate according to claim 5, wherein, in case that the halftone dots are AM halftone dots, a distribution of centers of the main halftone dot convexities forms a portion of a distribution of centers of the halftone dot convexities.

7. The printing relief plate according to claim 5, wherein centers of the main halftone dot convexities that are arranged in the dispersed fashion are distributed at vertices of a polygonal lattice, which is equilateral triangular shaped, square shaped, rectangular shaped, diamond shaped, parallelogram shaped, or regular hexagonal shaped, and wherein lengths of all sides or lengths of opposing sides of the polygonal lattice are equal.

8. The printing relief plate according to claim 7, wherein a positional error between center positions of the main halftone dot convexities and positions of vertices of a regular polygonal lattice the lengths of all sides of which are equal is ½ or less of a minimum value of the lengths of each of the sides that form the regular polygonal lattice.

9. The printing relief plate according to claim 5, wherein, in case that the halftone dots are FM halftone dots, a distribution of centers of the main halftone dot convexities is based on a distribution of centers of blue noise type FM halftone dots.

10. The printing relief plate according to claim 1, wherein the screen tint region is divided into halftone dot blocks, which are formed from a plurality of the halftone dot convexities that are adjacent to each other, an arrangement pattern of height levels of the halftone dot convexities in the halftone dot blocks being repeated periodically within the screen tint region.

11. The printing relief plate according to claim 10, wherein in case that the halftone dot blocks are constructed from 4×4 halftone dot convexities such that the heights of the halftone dot convexities are in three levels, the number of halftone dot convexities that make up the main halftone dot convexities of a first-level height, the height of which is highest, is two in number, the number of halftone dot convexities of a second-level height, which is next highest, is six in number, and the number of halftone dot convexities of a third-level height, which is lowest, is eight in number, and at adjacent halftone dot blocks having the same halftone dot convexity arrangement, sides of halftone dot convexities of the same level are arranged so as not to be shared.

12. The printing relief plate according to claim 10, wherein in case that the halftone dot blocks are constructed from 2×2 halftone dot convexities such that the heights of the halftone dot convexities are in three levels, the number of halftone dot convexities that make up the main halftone dot convexities of a first-level height, the height of which is highest, is one in number, the number of halftone dot convexities of a second-level height, which is next highest, is one in number, and the number of halftone dot convexities of a third-level height, which is lowest, is two in number, and at adjacent halftone dot blocks having the same halftone dot convexity arrangement, sides of halftone dot convexities of the same level are arranged so as not to be shared.

13. The printing relief plate according to claim 1, wherein the screen tint region is divided into halftone dot blocks, which are formed from a plurality of the halftone dot convexities that are adjacent to each other, an arrangement pattern of height levels of the halftone dot convexities in the halftone dot blocks being repeated periodically within the screen tint region, and
wherein in case that the halftone dot blocks are constructed from 2×2 halftone dot convexities such that the heights of the halftone dot convexities are in two levels, the number of halftone dot convexities that make up the main halftone dot convexities of a first-level height, the height of which is highest, is one in number, and the number of halftone dot convexities of a second-level height, which is next highest, is three in number, and halftone dot blocks having the same halftone dot convexity arrangement are arranged continuously.
